(19) United States
(12) Patent Application Publication
(10) Pub. No.: US 2023/0086270 A1
(43) Pub. Date: Mar. 23, 2023

(54) BATTERY AND BATTERY APPARATUS

(71) Applicant: CALB Co., Ltd., Jiangsu (CN)

(72) Inventors: Yifan Dong, Changzhou (CN); Ruijun Ma, Changzhou (CN); Xiaodong Xin, Changzhou (CN); Lulu Zhang, Changzhou (CN)

(73) Assignee: CALB Co., Ltd., Jiangsu (CN)

(21) Appl. No.: 17/523,893

(22) Filed: Nov. 10, 2021

(30) Foreign Application Priority Data
Sep. 23, 2021 (CN) 202111116817.1

(51) Int. Cl. H01M 50/145; H01M 50/583

(52) U.S. Cl. CPC H01M 50/145; H01M 50/583

(57) ABSTRACT

The disclosure provides a battery and a battery apparatus including the battery. The battery includes a housing, a positive current collector, a negative current collector and a resistor assembly. The positive current collector is disposed at the housing, and the negative current collector is disposed at the housing. The positive current collector is electrically connected to the housing through the resistor assembly, and the resistor assembly includes a first resistor and a second resistor arranged in parallel. A resistance value of the first resistor is greater than a resistance value of the second resistor. By arranging the first resistor and the second resistor arranged in parallel and configuring the resistance value of the first resistor to be greater than the resistance value of the second resistor, a total resistance value of the first resistor and the second resistor is less than the resistance value of the second resistor.

### CROSS-REFERENCE TO RELATED APPLICATION

This application claims the priority benefits of China application serial no. 202111116817.1, filed on Sep. 23, 2021. The entirety of the above-mentioned patent application is hereby incorporated by reference herein and made a part of this specification.

### BACKGROUND

### Technical Field

The disclosure relates to the technical field of batteries, and in particular, to a battery and a battery apparatus.

### Description of Related Art

In the related art, the positive current collector and the negative current collector of a battery is disposed in the housing. Since the positive current collector is insulated from the housing, the electric potential of the housing is lower. The problem of corrosion of the embedded lithium in the housing may thus occur, and battery performance is thereby affected.

### SUMMARY

The disclosure provides a battery and a battery apparatus.

According to the first aspect of the disclosure, the disclosure provides a battery, and the battery includes a housing, a positive current collector, a negative current collector and a resistor assembly. The positive current collector is disposed at the housing. The negative current collector is disposed at the housing. The positive current collector is electrically connected to the housing through the resistor assembly, and the resistor assembly includes a first resistor and a second resistor arranged in parallel. A resistance value of the first resistor is greater than a resistance value of the second resistor.

According to the second aspect of the disclosure, the disclosure further provides a battery apparatus including the abovementioned battery.

### BRIEF DESCRIPTION OF THE DRAWINGS

For a better understanding of the disclosure, reference may be made to exemplary embodiments shown in the following drawings. The components in the drawings are not necessarily to scale and related elements may be omitted, or in some instances proportions may have been exaggerated, so as to emphasize and clearly illustrate the features described herein. In addition, related elements or components can be variously arranged, as known in the art. Further, in the drawings, like reference numerals designate same or like parts throughout the several views.

FIG. 1 is a schematic diagram of a circuit structure of a battery according to a first exemplary embodiment.

FIG. 2 is a schematic diagram of a circuit structure of a battery apparatus according to an exemplary embodiment.

FIG. 3 is a schematic diagram of a circuit structure of a battery according to a second exemplary embodiment.

FIG. 4 is a schematic diagram of a circuit structure of a battery according to a third exemplary embodiment.

FIG. 5 is a schematic diagram of a circuit structure of a battery according to a fourth exemplary embodiment.

FIG. 6 is a schematic diagram of a circuit structure of a battery according to a fifth exemplary embodiment.

### DESCRIPTION OF THE EMBODIMENTS

The technical solutions in the exemplary embodiments of the disclosure will be described clearly and explicitly in conjunction with the drawings in the exemplary embodiments of the disclosure. The description proposed herein is just the exemplary embodiments for the purpose of illustrations only, not intended to limit the scope of the disclosure, so it should be understood that and various modifications and variations could be made thereto without departing from the scope of the disclosure.

In the description of the present disclosure, unless otherwise specifically defined and limited, the terms “first”, “second” and the like are only used for illustrative purposes and are not to be construed as expressing or implying a relative importance. The term “plurality” is two or more. The term “and/or” includes any and all combinations of one or more of the associated listed items.

In particular, a reference to “the” object or “a” and “an” object is intended to denote also one of a possible plurality of such objects. Unless otherwise defined or described, the terms “connect”, “fix” should be broadly interpreted, for example, the term “connect” can be “fixedly connect”, “detachably connect”, “integrally connect”, “electrically connect” or “signal connect”. The term “connect” also can be “directly connect” or “indirectly connect via a medium”. For the persons skilled in the art, the specific meanings of the abovementioned terms in the present disclosure can be understood according to the specific situation.

Further, in the description of the present disclosure, it should be understood that spatially relative terms, such as “above”, “below” “inside”, “outside” and the like, are described based on orientations illustrated in the figures, but are not intended to limit the exemplary embodiments of the present disclosure.

In the context, it should also be understood that when an element or features is provided “outside” or “inside” of another element(s), it can be directly provided “outside” or “inside” of the other element, or be indirectly provided “outside” or “inside” of the another element(s) by an intermediate element.

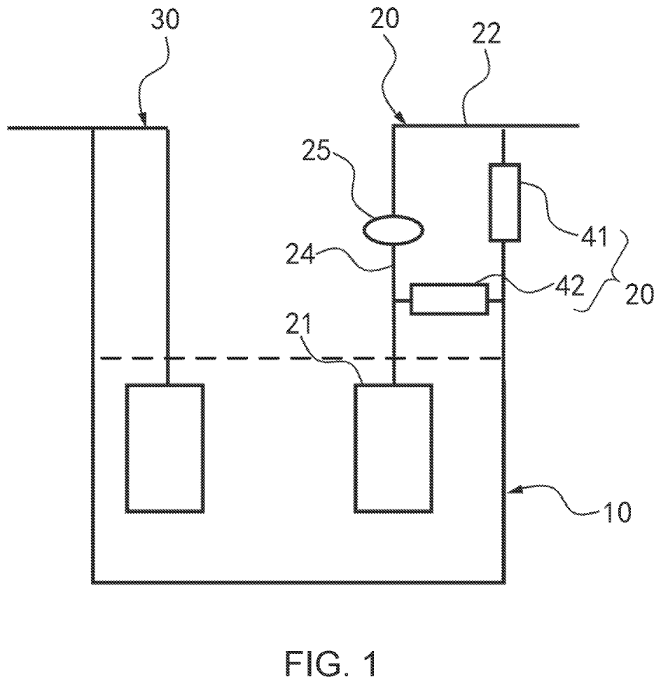

An embodiment of the disclosure provides a battery. With reference to FIG. 1 to FIG. 6, the battery includes a housing 10, a positive current collector 20, a negative current collector 30 and a resistor assembly 40. The positive current collector 20 is disposed at the housing 10. The negative current collector 30 is disposed at the housing 10. The positive current collector 20 is electrically connected to the housing 10 through the resistor assembly 40. The resistor assembly 40 includes a first resistor 41 and a second resistor 42 arranged in parallel. A resistance value of the first resistor 41 is greater than a resistance value of the second resistor 42.

In an embodiment of the disclosure, the battery includes the housing 10, the positive current collector 20, the negative current collector 30, and the resistor assembly 40. The positive current collector 20 is electrically connected to the housing 10 through the resistor assembly 40. The resistor assembly 40 includes the first resistor 41 and the second resistor 42 arranged in parallel, and a resistance value of the first resistor 41 is greater than a resistance value of the second resistor 42. As such, a total resistance value of the first resistor 41 and the second resistor 42 is less than the resistance value of the second resistor 42. In this way, an electric potential of the housing 10 may be increased, the housing 10 may be prevented from being corroded, and performance of the battery is thereby improved.

It should be noted that, as the resistance values of the first resistor 41 and the second resistor 42 are configured to be different and the first resistor 41 and the second resistor 42 are configured to be arranged in parallel; therefore, a resistor with a relatively small resistance value is connected in series between the positive current collector 20 and the housing 10. As such, an electric potential between the positive current collector 20 and the housing 10 is relatively high, and the housing 10 is thereby prevented from being corroded.

In an embodiment, the battery includes a cell and an electrolyte, and the battery is the smallest unit capable of performing electrochemical reactions such as charging/discharging. The cell refers to a unit formed by winding or laminating a stacked part, and the stacked part includes a first electrode, a separator and a second electrode. When the first electrode is a positive electrode, the second electrode is a negative electrode. The polarities of the first electrode and the second electrode may be interchanged. The cell may be disposed in the housing 10.

The positive current collector 20 and the negative current collector 30 may include portions of the cell. The positive current collector 20 may include a positive tab 21, and the negative current collector 30 may include a negative tab 31. The positive current collector 20 may further include a positive terminal component 22, and the negative current collector 30 may further include a negative terminal component 32. The positive tab 21 and the positive terminal component 22 are electrically connected, and the negative tab 31 and the negative terminal component 32 are electrically connected. As such, the cell may perform charging/discharging through the positive terminal component 22 and the negative terminal component 32.

In an embodiment, the positive current collector 20 and the negative current collector 30 are disposed on the housing 10. The positive terminal component 22 of the positive current collector 20 may be located on the housing 10, and the negative terminal component 32 of the negative current collector 30 may be located on the housing 10. A part of the positive terminal component 22 and a part of the negative terminal component 32 may be spaced apart from each other and disposed outside the housing 10.

In some embodiments, the positive current collector 20 and the negative current collector 30 are disposed in the housing 10. The positive tab 21 of the positive current collector 20 may be located in the housing 10, and the negative tab 31 of the negative current collector 30 may be located in the housing 10.

In an embodiment, the resistance value of the first resistor 41 is greater than or equal to 10 MΩ, and the resistance value of the second resistor ranges from 50Ω to 10,000Ω. As such, the total resistance value of the first resistor 41 and the second resistor 42 is less than 50Ω, so it is ensured that the potential between the positive current collector 20 and the housing 10 is maintained at a relatively high value, that is, it is ensured that the potential of the housing 10 is greater than a corrosion potential.

In some embodiments, a voltage between the positive current collector 20 and the housing 10 is less than or equal to 50 mV, that is, the electric potential of the housing 10 may be greater than a corrosion potential. The corrosion potential may be less than or equal to 2V.

In an embodiment, the first resistor 41 and the second resistor 42 of the resistor assembly 40 are not resistor devices provided by the related art. The first resistor 41 and the second resistor 42 may be other structures having specific resistance values. For instance, the first resistor 41 may be a structure made of an insulating material, and the insulating material may be rubber, polyphenylene sulfide, etc., such that the resistance value of the first resistor 41 is relatively large. The second resistor 42 may be a structure made of a semi-conductive material, and the semi-conductive material may be a conductive material made of a conductive fiber doped with polyphenylene sulfide, such that the resistance of the second resistor 42 is relatively small.

In an embodiment, the first resistor 41 includes one or more of a mica insulating material, ceramic, synthetic resin, insulating glue, a fiber product, rubber, plastic and asbestos, such that the resistance value of the first resistor 41 is greater than or equal to 10 M.

A material of the first resistor 41 may be one of a mica insulating material, ceramic, synthetic resin, insulating glue, a fiber product, rubber, plastic and asbestos. Alternatively, the material of the first resistor 41 may be a combination of at least two of a mica insulating material, ceramic, synthetic resin, insulating glue, a fiber product, rubber, plastic and asbestos, so that it is ensured that the first resistor 41 has a relatively large resistance value.

In an embodiment, the second resistor 42 includes one or more of a carbon film resistor, a metal film resistor, a metal oxide and a semiconductor material, such that the resistance value range of the second resistor is 50Ω to 10,000Ω. The metal oxide may be a zinc oxide, an aluminum oxide, etc., and the semiconductor material may be doped silicon, gallium arsenide, aluminum gallium arsenide, etc.

A material of the second resistor 42 may be one of a carbon film resistor, a metal film resistor, a zinc oxide, doped silicon, gallium arsenide and aluminum gallium arsenide. Alternatively, the material of the second resistor 42 may be a combination of at least two of a carbon film resistor, a metal film resistor, a zinc oxide, doped silicon, gallium arsenide and aluminum gallium arsenide, so that it is ensured that the second resistor 42 has a relatively small resistance value.

In an embodiment, the positive current collector 20 includes a fusing structure 25. Herein, when a current passing through the fusing structure 25 exceeds a threshold value, the fusing structure 25 disconnects the electrical connection between the positive current collector 20 and the second resistor 42. As such, it is thereby ensured that when a short circuit is present in the battery, if a current still exists between the positive current collector 20 and the housing 10, a larger resistance value may be provided between the positive current collector 20 and the housing 10, and a thermal runaway problem may thus be prevented from occurring.

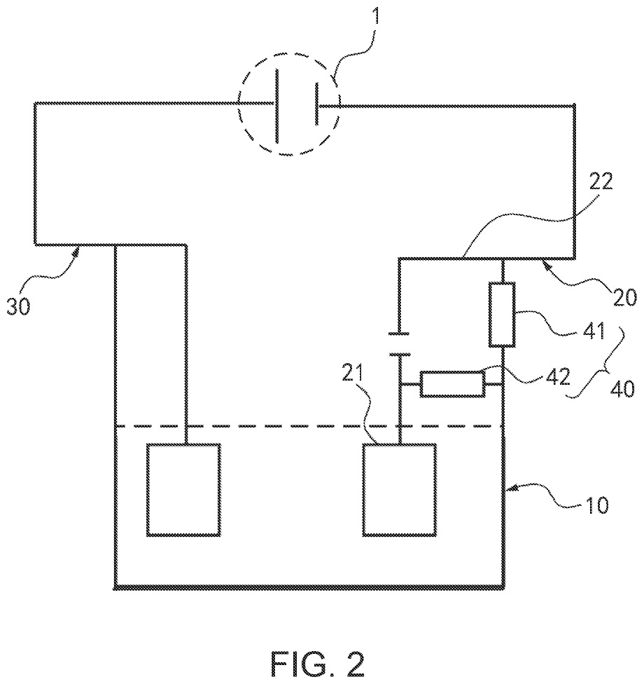

It should be noted that, as shown in FIG. 1, the positive current collector 20 includes the fusing structure 25, and the first resistor 41 and the second resistor 42 are arranged between the positive current collector 20 and the housing 10. As shown in FIG. 2, when the battery is connected into a battery apparatus 1, if there is a short circuit inside the battery, for example, the positive terminal component 22 of the positive current collector 20 and the negative terminal component 32 of the negative current collector 30 are directly connected, due to the presence of the battery apparatus 1, the battery apparatus 1 may apply a reverse high voltage to the short-circuited battery. At this time, the fusing structure 25 is disconnected, and the resistor through which the current flows between the positive current collector 20 and the housing 10 is the first resistor 41. Since the resistance value of the first resistor 41 is larger, the first resistor 41 may not be broken down, and the thermal runaway problem may thus be prevented from occurring.

The fusing structure 25 disconnects the electrical connection between the positive current collector 20 and the second resistor 42, that is, the current between the positive current collector 20 and the housing 10 may not flow through the second resistor 42. In some embodiments, after the fusing structure 25 disconnects the electrical connection between the positive current collector 20 and the second resistor 42, the current between the positive current collector 20 and the housing 10 f only lows through the first resistor 41. Since the resistance value of the first resistor 41 is larger, the first resistor 41 may not be broken down, and the thermal runaway problem may thus be prevented from occurring. In some embodiments, after the fusing structure 25 disconnects the electrical connection between the positive current collector 20 and the second resistor 42, the battery apparatus 1 may be directly disconnected from the battery, that is, there is no current between the positive current collector 20 and the housing 10, and the thermal runaway problem may thus be prevented from occurring.

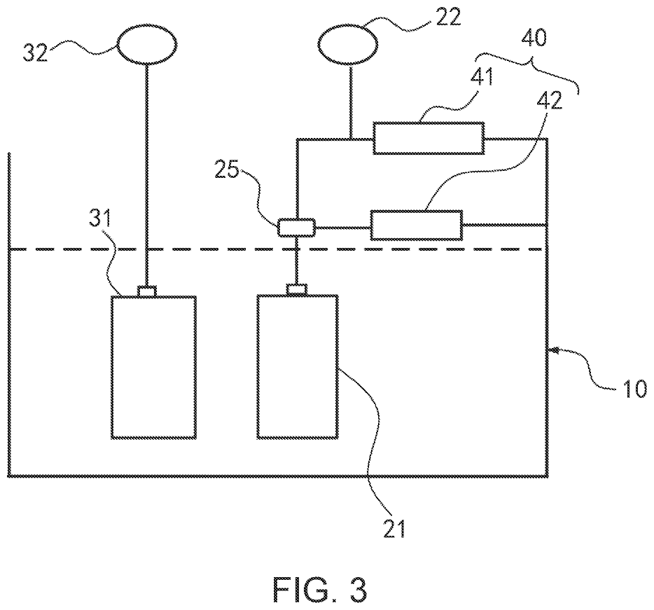

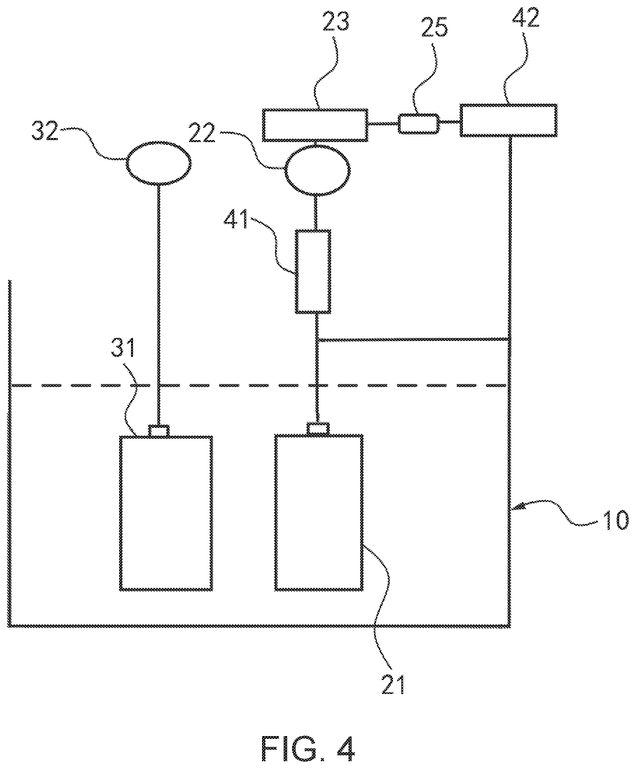

In an embodiment, as shown in FIG. 3 and FIG. 4, the positive current collector 20 further includes the positive terminal component 22, and the housing 10 includes a first housing member and a second housing member connected to each other. Herein, the first resistor 41 is disposed between the positive terminal component 22 and the first housing member, or the first resistor 41 is disposed between the positive terminal component 22 and the second housing member, so that it is ensured that the positive terminal component 22 and the first housing member are connected to each other at least through the first resistor 41. When the battery is in normal use, the first resistor 41 and the second resistor 42 are connected in parallel, so that the problem of corrosion is prevented from occurring. When an excessive current occurs, the fusing structure 25 is disconnected. When a current is provided between the positive current collector 20 and the housing 10, the current may only flow through the first resistor 41, so that the thermal runaway problem is prevented through the first resistor 41.

When the housing 10 is electrically connected to both the first resistor 41 and the second resistor 42, that is, the positive terminal component 22 supplies power to both the first resistor 41 and the second resistor 42, since the first resistor 41 and the second resistor 42 are connected in parallel, the total resistance value is smaller, and the problem of corrosion is prevented from occurring. When the positive terminal component 22 supplies power to the first resistor 41, since the resistance value of the first resistor 41 is larger, the battery is protected, and thermal runaway is prevented from occurring.

In an embodiment, as shown in FIG. 3, the positive current collector 20 further includes the positive tab 21. The fusing structure 25 is connected to the positive tab 21 and the positive terminal component 22, and the second resistor 42 is disposed between the fusing structure 25 and the housing 10. When the current passing through the fusing structure 25 exceeds the threshold value, the fusing structure 25 disconnects the electrical connection between the positive tab 21 and the positive terminal component 22 and the electrical connection between the positive tab 21 and the second resistor 42. In this way, the first resistor 41 may act as an insulator between the positive terminal component 22 and the housing 10, and the thermal runaway problem is accordingly prevented from occurring. In this embodiment, both the first resistor 41 and the second resistor 42 may be disposed between housing 10 and the positive terminal component 22.

In an embodiment, the positive tab 21 and the positive terminal component 22 may be directly connected to each other through the fusing structure 25. The fusing structure 25 may be a fuse structure for safety, and the fuse structure may be at least one of a wire and a fuse. A material of the fuse structure may be selected from a conductive material such as conductive metal, a conductive metal oxide, or other conductive inorganic materials. An insulating structure may be wrapped on a surface of the fuse structure, and the insulating structure may protect the fuse structure.

In an embodiment, as shown in FIG. 1, the positive current collector 20 further includes an adapter piece 24, and the positive tab 21 and the positive terminal component 22 may be connected to each other through the adapter piece 24. At this time, a connection path between the positive tab 21 and the positive terminal component 22 may be further provided with the fusing structure 25. The fusing structure 25 may be a fuse structure, and the fuse structure may be at least one of a wire and a fuse. Alternatively, the fusing structure 25 is disposed on the adapter piece 24. As such, when the fusing structure 25 is disconnected, the adapter piece 24 is also disconnected, and the electrical connection between the positive tab 21 and the positive terminal component 22 and the electrical connection between the positive tab 21 and the second resistor 42 are thereby disconnected.

In some embodiments, the fusing structure 25 may be a portion of the adapter piece 24. For instance, a through hole is provided on the adapter piece 24, so an area of the adapter piece 24 is decreased, and the fusing structure 25 is formed.

In an embodiment, as shown in FIG. 4, the positive current collector 20 further includes a busbar 23. The positive terminal component 22 is electrically connected to the busbar 23, and the fusing structure 25 is connected to the busbar 23 and the second resistor 42. Herein, the second resistor 42 is disposed between the fusing structure 25 and the housing 10. When the current passing through the fusing structure 25 exceeds the threshold value, the fusing structure 25 disconnects the electrical connection between the busbar 23 and the second resistor 42, that is, the electrical connection between the positive terminal component 22 and the second resistor 42 is disconnected. In this way, the first resistor 41 may act as an insulator between the positive terminal component 22 and the housing 10, and the thermal runaway problem is accordingly prevented from occurring. After the fusing structure 25 is disconnected, the current of the battery apparatus 1 is transferred to the first resistor 41 through the busbar 23 and the positive terminal component 22, and thus passes through the housing 10. Due to the presence of the first resistor 41, the electric potential on the housing 10 may not be excessively high, and protection is thereby effectively provided. In this embodiment, the first resistor 41 may be disposed between the housing 10 and the positive terminal component 22, and the second resistor 42 may be disposed between the housing 10 and the busbar 23.

It should be noted that, when the first resistor 41 is located between the positive tab 21 and the positive terminal component 22, the resistance value of the first resistor 41 is required to be kept below a predetermined value, such that the electrical connection between the positive tab 21 and the positive terminal component 22 is ensured, so as to accordingly ensure the normal use of the battery.

In an embodiment, the fusing structure 25 is disposed on the busbar 23. As such, when the fusing structure 25 is disconnected, the busbar 23 is disconnected, and the power supply from the battery apparatus 1 to the battery is thereby disconnected. The busbar 23 is configured to implement the series connection and parallel connection between the batteries. Therefore, after the busbar 23 is disconnected, the connection between the batteries may be disconnected, and the problem of reverse high voltage may not occur in a single battery.

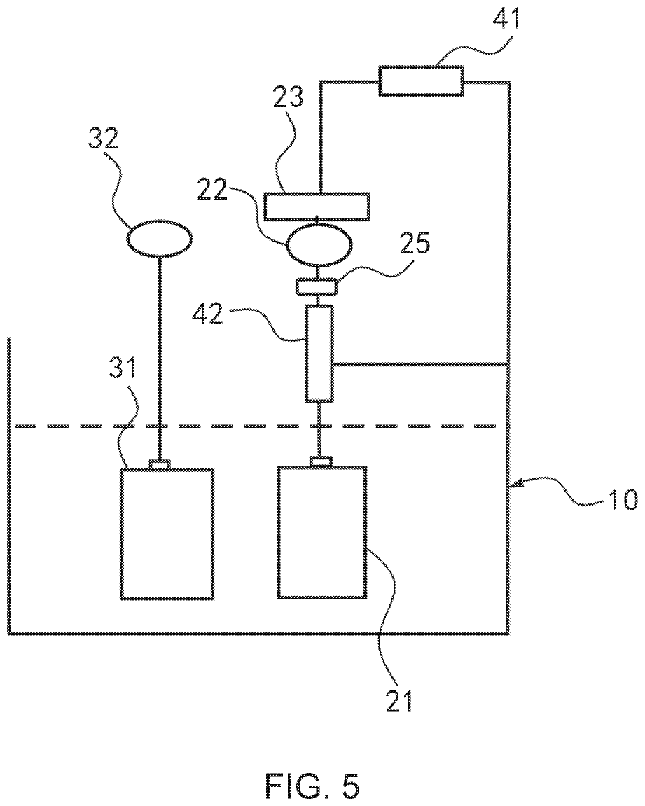

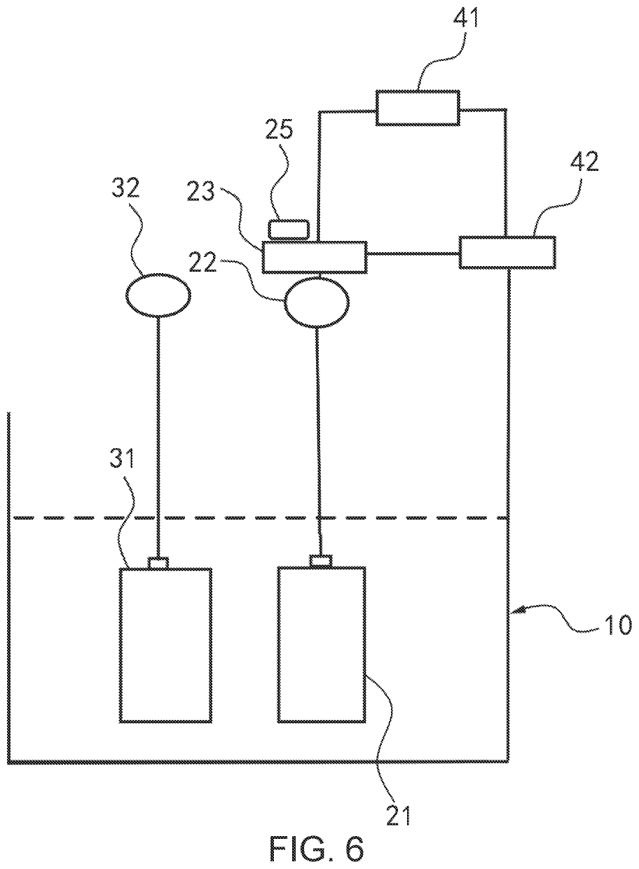

In an embodiment, as shown in FIG. 5 and FIG. 6, the housing 10 includes the first housing member and the second housing member connected to each other. The positive current collector 20 may further include the positive terminal component 22 and the busbar 23, and the positive terminal component 22 is electrically connected to the busbar 23. Herein, the first resistor 41 is disposed between the busbar 23 and the first housing member, or the first resistor 41 is disposed between the busbar 23 and the second housing member. As such, the first resistor 41 may be conveniently installed, and it is also ensured that the positive terminal component 22 and the first housing member are connected to each other at least through the first resistor 41. When the battery is in normal use, the first resistor 41 and the second resistor 42 are connected in parallel, so that the problem of corrosion is prevented from occurring. When an excessive current occurs, the fusing structure 25 is disconnected. When a current is provided between the positive current collector 20 and the housing 10, the current may only flow through the first resistor 41, so that the thermal runaway problem is prevented through the first resistor 41.

In an embodiment, as shown in FIG. 5, the positive current collector 20 further includes the positive tab 21, and the fusing structure 25 is connected to the positive tab 21 and the positive terminal component 22. Herein, the second resistor 42 is disposed between the fusing structure 25 and the housing 10. When the current passing through the fusing structure 25 exceeds the threshold value, the fusing structure 25 disconnects the electrical connection between the positive tab 21 and the positive terminal component 22 and the electrical connection between the positive tab 21 and the second resistor 42. In this way, the first resistor 41 may act as an insulator between the busbar 23 and the housing 10, and the thermal runaway problem is accordingly prevented from occurring. After the fusing structure 25 is disconnected, the current of the battery apparatus 1 is transferred to the first resistor 41 through the busbar 23, and thus passes through the housing 10. Due to the presence of the first resistor 41, the electric potential on the housing 10 may not be excessively high, and protection is thereby effectively provided. In this embodiment, the first resistor 41 is disposed between the housing 10 and the busbar 23, and the second resistor 42 is disposed between the housing 10 and the positive terminal component 22. In some embodiments, the second resistor 42 may not be provided to be connected between the positive tab 21 and the positive terminal component 22.

Alternatively, the second resistor 42 may be provided to be connected between the positive tab 21 and the positive terminal component 22, as shown in FIG. 5.

In an embodiment, the first resistor 41 is disposed between the busbar 23 and the first housing member. Alternatively, when the first resistor 41 is disposed between the busbar 23 and the second housing member, the fusing structure 25 may be disposed on the busbar 23. As such, when the fusing structure 25 is disconnected, the busbar 23 is disconnected, and the power supply from the battery apparatus 1 to the battery is thereby disconnected.

In an embodiment, as shown in FIG. 6, the second resistor 42 is disposed between the busbar 23 and the first housing member, or the second resistor 42 is disposed between the busbar 23 and the second housing member, and the fusing structure 25 is disposed on the busbar 23. As such, when the fusing structure 25 is disconnected, the busbar 23 is disconnected, and the power supply from the battery apparatus 1 to the battery is thereby disconnected, and the thermal runaway problem is prevented from occurring. In this embodiment, both the first resistor 41 and the second resistor 42 may be disposed between the housing 10 and the busbar 23.

It should be noted that, the busbar 23 is located outside the housing 10. Therefore, when the first resistor 41 and the second resistor 42 are disposed between the housing 10 and the busbar 23, the first resistor 41 and the second resistor 42 are located outside the housing 10. A portion of the positive terminal component 22 may be located outside the housing 10. When the first resistor 41 and the second resistor 42 are disposed between the housing 10 and the positive terminal component 22, the first resistor 41 and the second resistor 42 are located outside the housing 10. A portion of the positive terminal component 22 may be located inside the housing 10. When the first resistor 41 and the second resistor 42 are disposed between the housing 10 and the positive terminal component 22, the first resistor 41 and the second resistor 42 are located inside the housing 10.

In an embodiment, the first housing member and the second housing member are connected to each other to form a sealed space for sealing the cell. The first housing member or the second housing member may be a cover.

It should be noted that, the structure of the negative current collector 30 is not particularly limited herein, and description thereof may be found with reference to the description of the positive current collector 20. For instance, the negative current collector 30 may include the negative tab 31 and the negative terminal component 32, and the negative tab 31 and the negative terminal component 32 may be directly connected to each other. Alternatively, the negative tab 31 may be connected to the negative terminal component 32 through an adapter piece. The negative current collector 30 may further include a busbar, a fusing structure, or a resistor assembly.

In the battery provided by the embodiments of the disclosure, the first resistor having a large resistance value is connected in series between the positive terminal component and the housing, so the thermal runaway problem caused by the reverse high voltage is prevented. At the same time, the second resistor having a small resistance value is connected between the fusing structure and the housing, and the first resistor and the second resistor are connected in parallel, such that the problem of corrosion is prevented from occurring in the housing.

An embodiment of the disclosure further provides a battery apparatus including the abovementioned battery.

A battery apparatus provided by an embodiment of the disclosure includes the battery, and the battery includes the housing 10, the positive current collector 20, the negative current collector 30 and the resistor assembly 40. The positive current collector 20 is electrically connected to the housing 10 through the resistor assembly 40. The resistor assembly 40 includes the first resistor 41 and the second resistor 42 arranged in parallel, and the resistance value of the first resistor 41 is greater than the resistance value of the second resistor 42. As such, the total resistance value of the first resistor 41 and the second resistor 42 is less than the resistance value of the second resistor 42. In this way, the electric potential of the housing 10 may be increased, the housing 10 may be prevented from being corroded, and performance of the battery apparatus is thereby improved.

In an embodiment, the battery apparatus includes a plurality of batteries, and the plurality of batteries may be connected in series and/or in parallel. The batteries may be connected in series or parallel via the busbar.

In an embodiment, the battery apparatus may a battery module or a battery pack.

The battery module includes a plurality of batteries, and the plurality of batteries may be secured through end plates and side plates.

The battery pack includes a plurality of batteries and a battery box, and the battery box is configured to secure the plurality of batteries.

It should be noted that, the battery pack includes the battery, the battery may be multiple, and the multiple batteries are arranged in the box. Herein, after forming the battery module, the batteries may be installed in the box. Herein, the battery module may include the end plates and the side plates configured for securing the batteries. Alternatively, the batteries may be directly disposed in the box, that is, the batteries are not required to be arranged into groups, and the end plates and the side plates may be removed at this time.

Other embodiments of the disclosure will be apparent to those skilled in the art from consideration of the specification and practice of the disclosure disclosed herein. The disclosure is intended to cover any variations, uses or adaptations of the disclosure. These variations, uses, or adaptations follow the general principles of the disclosure and include common general knowledge or conventional technical means in the art that are not disclosed in the present disclosure. The specification and embodiments are illustrative, and the real scope and spirit of the present disclosure is defined by the appended claims.

It should be understood that the disclosure is not limited to the precise structures that have been described above and shown in the drawings, and various modifications and variations can be made without departing from the scope thereof. The scope of the disclosure is limited only by the appended claims.

What is claimed is:

1. A battery, comprising:
a housing;
a positive current collector, disposed at the housing;
a negative current collector, disposed at the housing; and
a resistor assembly, wherein the positive current collector is electrically connected to the housing through the resistor assembly, and the resistor assembly comprises a first resistor and a second resistor arranged in parallel,
wherein a resistance value of the first resistor is greater than a resistance value of the second resistor.

2. The battery according to claim 1, wherein the resistance value of the first resistor is greater than or equal to 10 MΩ, and the resistance value of the second resistor ranges from 50Ω to 10,000 Ω.

3. The battery according to claim 1, wherein the positive current collector comprises a fusing structure,
wherein when a current passing through the fusing structure exceeds a threshold value, the fusing structure disconnects an electrical connection between the positive current collector and the second resistor.

4. The battery according to claim 3, wherein the positive current collector further comprises a positive terminal component, and the housing comprises a first housing member and a second housing member connected to each other,
wherein the first resistor is disposed between the positive terminal component and the first housing member, or the first resistor is disposed between the positive terminal component and the second housing member.

5. The battery according to claim 4, wherein the positive current collector further comprises a positive tab, the fusing structure is connected to the positive tab and the positive terminal component, and the second resistor is disposed between the fusing structure and the housing.

6. The battery according to claim 5, wherein the positive current collector further comprises an adapter piece, and the fusing structure is disposed on the adapter piece.

7. The battery according to claim 4, wherein the positive current collector further comprises a busbar, the positive terminal component is electrically connected to the busbar, and the fusing structure is connected to the busbar and the second resistor,
wherein the second resistor is disposed between the fusing structure and the housing.

8. The battery according to claim 7, wherein the fusing structure is disposed on the busbar.

9. The battery according to claim 3, wherein the housing comprises a first housing member and a second housing member connected to each other, the positive current collector further comprises an positive terminal component and a busbar, and the positive terminal component is electrically connected to the busbar,
wherein the first resistor is disposed between the busbar and the first housing member, or the first resistor is disposed between the busbar and the second housing member.

10. The battery according to claim 9, wherein the positive current collector further comprises a positive tab, and the fusing structure is connected to the positive tab and the positive terminal component,
wherein the second resistor is disposed between the fusing structure and the housing.

11. The battery according to claim 9, wherein the fusing structure is disposed on the busbar.

12. The battery according to claim 9, wherein the second resistor is disposed between the busbar and the first housing member, or the second resistor is disposed between the busbar and the second housing member.

13. The battery according to claim 4, wherein the first housing member or the second housing member is a cover.

14. The battery according to claim 1, wherein the first resistor comprises one or more of a mica insulating material, ceramic, synthetic resin, insulating glue, a fiber product, rubber, plastic and asbestos, and/or
the second resistor comprises one or more of a carbon film resistor, a metal film resistor, a metal oxide and a semiconductor material.

15. A battery apparatus, comprising the battery according to claim 1.

16. The battery apparatus according to claim 15, wherein the battery apparatus is a battery module or a battery pack.
